(19) United States
(12) Patent Application Publication
(10) Pub. No.: US 2017/0263958 A1
(43) Pub. Date: Sep. 14, 2017

(54) HYDROGEN SUPPLY SUPPORTING SYSTEM

(71) Applicant: SANWA CHEMICAL CO., LTD., Osaka (JP)

(72) Inventor: Jyuuichi Mutou, Osaka-shi (JP)

(73) Assignee: SANWA CHEMICAL CO., LTD., Osaka (JP)

(21) Appl. No.: 15/448,923

(22) Filed: Mar. 3, 2017

(30) Foreign Application Priority Data
Mar. 10, 2016 (JP) 2016-046381

(51) Int. Cl. H01M 8/04082; H04L 29/08

(52) U.S. Cl. CPC H01M 8/04201; H04L 67/125; H04L 67/025; H01M 2250/20

(57) ABSTRACT

A reception-side terminal apparatus transmits reception request data to a management server apparatus, the reception request data containing the vessel ID of the fuel-cell vessel, a date and time, a position, and an amount requested for reception of hydrogen. A supply-side terminal apparatus transmits supply offer data to the management server apparatus, the supply offer data containing the vessel ID of the hydrogen supplier vessel, a date and time, a position, and an amount allowing supply of hydrogen. The management server apparatus generates supply schedule data based on the reception request data and the supply offer data, the supply schedule data containing the vessel ID of a fuel-cell vessel to receive the supply of hydrogen, the vessel ID of a hydrogen supplier vessel to supply hydrogen to the fuel-cell vessel, and a scheduled date and time, a scheduled position, and a scheduled amount for supplying hydrogen to the fuel-cell vessel.

### CROSS REFERENCE OF RELATED APPLICATIONS

The disclosure of Japanese Patent Applications No. 2016-046381 (filed Mar. 10, 2016) including the specification, claims, drawings and abstract is incorporated herein by reference in its entirety.

### BACKGROUND OF THE INVENTION

Field of the Invention

The present invention relates to a hydrogen supply supporting system, in particular, to a technique for supplying hydrogen to a hydrogen receiver vessel such as a fuel-cell vessel.

Description of the Related Art

A fuel-cell vessel, which navigates using a fuel cell as a motive power source, has been proposed (e.g., Japanese Patent Laid-Open No. 2015-196412). This fuel-cell vessel includes a fuel tank for storing hydrogen, a fuel cell for generating electricity by causing hydrogen supplied from the fuel tank to react with oxygen taken from the air, a battery for accumulating the electricity generated by the fuel cell, a motor to which electricity is supplied from the battery, and a propeller driven by the motor, and is configured to produce thrust with the propeller (see paragraphs [0016] to [0020], FIG. 1, and FIG. 4 and the like of Japanese Patent Laid-Open No. 2015-196412).

Using fuel-cell vessels suppresses the consumption of fossil fuels, and reduces carbon dioxide and harmful gasses in waterborne transportation means, which is in turn expected to contribute to the prevention of global warming and air pollution.

Now, in the case of using fuel-cell vessels in long-distance navigation such as ocean lines, the fossil fuel consumption of which accounts for a significant amount in waterborne transportation means, it is necessary to develop a lot of ports that allow the supply of hydrogen as well as to increase a frequency of port calls for refueling because fuel-cell vessels generally have short cruising distances as compared with fossil-fueled vessels.

However, although the development of a lot of ports allowing the supply of hydrogen may be possible in the future, increasing in frequency of port calls for refueling prolongs a navigation distance and a required time to a destination, which raises a problem of decreasing transport efficiency.

To solve such a problem, it is conceivable to increase the volume of a fuel tank for storing hydrogen to enable a long-distance navigation without increasing in frequency of port calls for refueling. However, increasing the volume of a fuel tank for storing hydrogen accordingly reduces space for persons or cargoes, which still results in decreasing transport efficiency.

In contrast, a system in which a fuel-cell vessel on its own produces hydrogen (e.g., National Publication of International Patent Application No. 2004-506575) has been proposed. In this system, water obtained from a water source such as ocean water is subjected to water treatment such as desalinization using a water-purifying device, so that product water is obtained, and from the obtained product water, hydrogen gas is produced using a converter such as an electrolyzer. Power for these electrical components including the water-purifying device and the electrolyzer is supplied from a power source such as a solar electric system (photovoltaic cells), a wind turbine generator, and a water drag generator (hydroelectricity) (see paragraphs [0016] to [0021], FIG. 1, and the like of National Publication of International Patent Application No. 2004-506575).

Although using such a system enables a long-distance navigation without the supply of hydrogen from the outside, it requires space for facilities necessary to produce hydrogen and accordingly reduces space for persons or cargoes, which still results in decreasing transport efficiency.

### SUMMARY OF THE INVENTION

The present invention has an objective to solve such existing problems and to provide a system and the like, for hydrogen receiver vessels such as fuel-cell vessels, that enables long-distance navigations without resulting in decreasing transport efficiency.

A hydrogen supply supporting system according to the present invention is a hydrogen supply supporting system including reception-side terminal apparatuses that are provided, respectively, in a plurality of hydrogen receiver vessels to receive supply of hydrogen, supply-side terminal apparatuses that are provided, respectively, in a plurality of hydrogen supplier vessels to supply hydrogen, and a management server apparatus that can communicate information with the reception-side terminal apparatuses and the supply-side terminal apparatuses via information communication means, the hydrogen supply supporting system supporting supply of hydrogen from the hydrogen supplier vessel to the hydrogen receiver vessel on a course of the hydrogen receiver vessel, wherein the reception-side terminal apparatuses each include a reception-side controller including: a reception-side data transmitting unit that transmits reception request data to the management server apparatus, the reception request data containing a vessel ID to identify the vessel, and a date and time, a position, and an amount requested for reception of hydrogen; and a reception-side data accepting unit that accepts supply schedule data corresponding to reception request data from the management server apparatus, and the supply-side terminal apparatuses each include a supply-side controller including: a supply-side data transmitting unit that transmits supply offer data to the management server apparatus, the supply offer data containing a vessel ID to identify the vessel, and a date and time, a position, and an amount allowing supply of hydrogen; and a supply-side data accepting unit that accepts supply schedule data corresponding to supply offer data from the management server apparatus, and the management server apparatus includes a management-side controller including: a management-side data accepting unit that accepts reception request data from the reception-side terminal apparatus and accepts supply offer data from the supply-side terminal apparatus; a supply schedule data generating unit that generates, based on the accepted reception request data and supply offer data, supply schedule data containing a vessel ID of a certain hydrogen receiver vessel to receive supply of hydrogen, a vessel ID of a certain hydrogen supplier vessel to supply hydrogen to the certain hydrogen receiver vessel, and a scheduled date and time, a scheduled position, and a scheduled amount for supplying hydrogen to the certain hydrogen receiver vessel; and a management-side data transmitting unit that transmits the supply schedule data to the reception-side terminal apparatus and the supply-side terminal apparatus.

In the present invention, it should be noted that the information communication means refers to communication means, of either wired or wireless, for transmitting information such as characters, sounds, images, videos, and control signals converted into an electric signal, optical signal, or the like, unless otherwise stated. Examples of the information communication means includes a wide area network (WAN) represented by the Internet, a computer network such as a local area network (LAN), a communication line such as a telephone line (including a mobile telephone line) and a private line, communication via a communications satellite, direct communication using a communication cable, infrared light, or the like, or combinations thereof.

Although the features of the present invention can be expressed as described above in a broad sense, the configuration and content of the present invention, as well as the objectives and features thereof, will be apparent with reference to the following disclosure, taken in connection with the accompanying drawings.

### BRIEF DESCRIPTION OF THE DRAWINGS

FIG. 1 is a block diagram illustrating a general configuration of a hydrogen supply supporting system 2 according to an embodiment of the present invention;

FIG. 2 is a block diagram illustrating a configuration of a reception-side terminal apparatus 5, a supply-side terminal apparatus 6, and a management server apparatus 4, which are components of a hydrogen supply supporting system 2;

FIG. 3 is a block diagram illustrating an example of a hardware configuration of the management server apparatus 4 and the reception-side terminal apparatus 5 illustrated in FIG. 2, illustrating a case where one computer is used for each of the management server apparatus 4 and the reception-side terminal apparatus 5;

FIG. 4 is a flowchart illustrating an example of a process flow in the hydrogen supply supporting system 2;

FIG. 5 is a flowchart illustrating the process of step S4 in FIG. 4 in detail;

FIG. 6A is a diagram illustrating an example of the data configuration of a reception request table 70; and

FIG. 6B is a diagram illustrating an example of the data configuration of a supply offer table 71.

### DETAILED DESCRIPTION OF THE PREFERRED EMBODIMENT

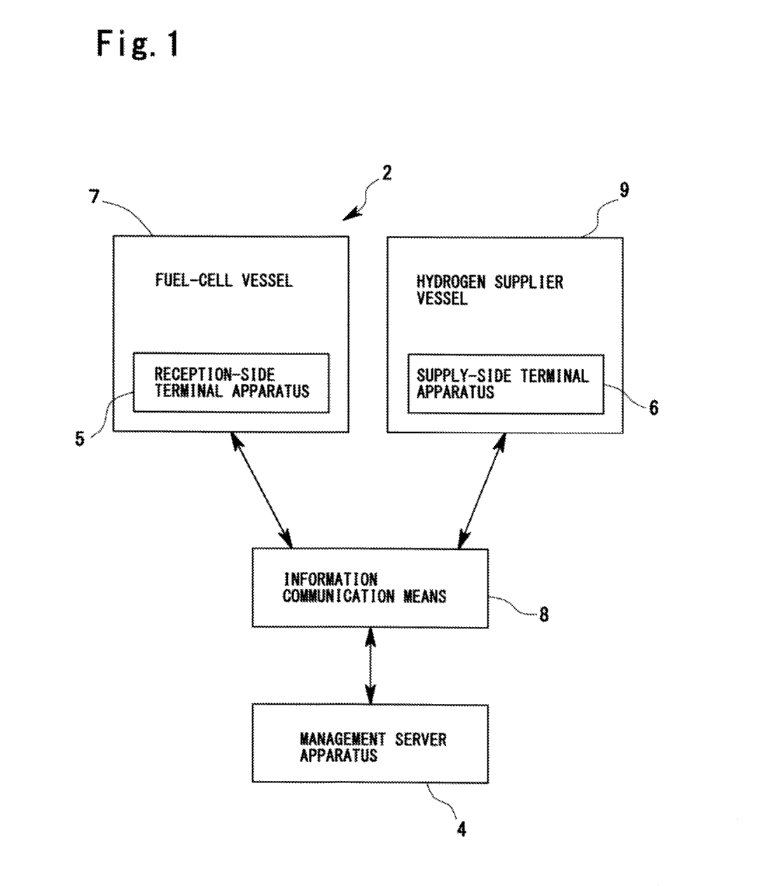

FIG. 1 is a block diagram illustrating a general configuration of a hydrogen supply supporting system 2 according to an embodiment of the present invention.

The hydrogen supply supporting system 2 includes a reception-side terminal apparatus 5 installed in a fuel-cell vessel 7, which is a hydrogen receiver vessel receiving the supply of hydrogen, a supply-side terminal apparatus 6 installed in a hydrogen supplier vessel 9, which supplies hydrogen, and a management server apparatus 4. The hydrogen supply supporting system 2 allows the management server apparatus 4 to communicate information with the reception-side terminal apparatus 5 and the supply-side terminal apparatus 6 via information communication means 8.

Use is made of the hydrogen supply supporting system 2 to support the supply of hydrogen from the hydrogen supplier vessel 9 to the fuel-cell vessel 7, on a course of the fuel-cell vessel 7.

The fuel-cell vessel 7 is equipped with a fuel cell using hydrogen as fuel, and has, for example, the same configuration as that of the fuel-cell vessel in Japanese Patent Laid-Open No. 2015-196412 described above.

The hydrogen supplier vessel 9 includes a hydrogen storage tank for supplying hydrogen to the fuel-cell vessel 7. The hydrogen storage tank is not limited in its storage scheme in particular, and may store liquid hydrogen or store gaseous hydrogen using, for example, a hydrogen-storing alloy.

How to supply the hydrogen supplier vessel 9 with hydrogen to be supplied to fuel-cell vessel 7 is not limited in particular, and the hydrogen supplier vessel 9 may receive the supply from a hydrogen supply base set up on land or at sea, or the hydrogen supplier vessel 9 on its own may produce hydrogen. Alternatively, the hydrogen supplier vessel 9 may receive the supply of hydrogen from another hydrogen supplier vessel 9.

The scheme in which hydrogen is supplied from the hydrogen supplier vessel 9 to the fuel-cell vessel 7 is not limited in particular, and hydrogen may be supplied in the form of liquid hydrogen or in the form of gaseous hydrogen. Alternatively, at the time of the supply, hydrogen may be transferred between both vessels using piping such as a pipe and a hose, or hydrogen charged in a tank may be transferred together with the tank.

Although FIG. 1 illustrates only one reception-side terminal apparatus 5 and one supply-side terminal apparatus 6 for convenience of description, this system 2 includes a plurality of reception-side terminal apparatuses 5 respectively built in a plurality of fuel-cell vessels 7 (i.e., a plurality of hydrogen receiver vessels) and a plurality of supply-side terminal apparatuses 6 respectively built in a plurality of hydrogen supplier vessels 9.

The installation location of the management server apparatus 4 is not limited in particular, and may be installed, for example, in a management base on land or at sea or may be attached to the hydrogen supplier vessel 9.

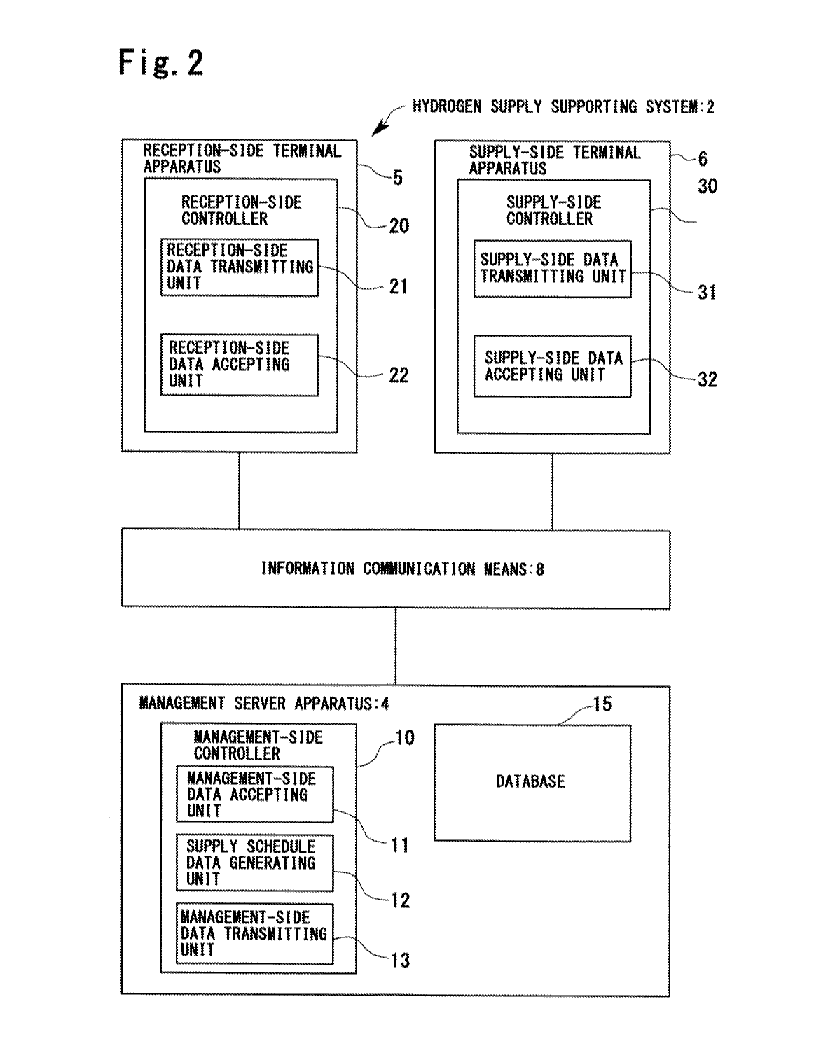

FIG. 2 is a block diagram illustrating a configuration of the reception-side terminal apparatus 5, the supply-side terminal apparatus 6, and the management server apparatus 4, which are components of the hydrogen supply supporting system 2.

As illustrated in FIG. 2, the reception-side terminal apparatus 5 includes a reception-side controller 20. The reception-side controller 20 includes a reception-side data transmitting unit 21 and a reception-side data accepting unit 22.

The reception-side data transmitting unit 21 transmits reception request data to the management server apparatus 4, the reception request data containing a vessel ID to identify the fuel-cell vessel 7, and a date and time, a position, and an amount requested for the reception of hydrogen. The reception-side data accepting unit 22 accepts supply schedule data corresponding to the reception request data from the management server apparatus 4.

The supply-side terminal apparatus 6 includes a supply-side controller 30. The supply-side controller 30 includes a supply-side data transmitting unit 31 and a supply-side data accepting unit 32.

The supply-side data transmitting unit 31 transmits supply offer data to the management server apparatus 4, the supply offer data containing a vessel ID to identify the hydrogen supplier vessel 9, and a date and time, a position, and an amount allowing the supply of hydrogen. The supply-side data accepting unit 32 accepts supply schedule data corresponding to the supply offer data from the management server apparatus 4.

The management server apparatus 4 includes a management-side controller 10 and a database 15.

The management-side controller 10 includes a management-side data accepting unit 11, a supply schedule data generating unit 12, and a management-side data transmitting unit 13.

The management-side data accepting unit 11 accepts reception request data from the reception-side terminal apparatus 5 and accepts supply offer data from the supply-side terminal apparatus 6.

Based on the accepted reception request data and supply offer data, the supply schedule data generating unit 12 generates supply schedule data that contains the vessel ID of a certain fuel-cell vessel 7 to receive the supply of hydrogen, the vessel ID of a certain hydrogen supplier vessel 9 to supply hydrogen to the fuel-cell vessel 7, a scheduled date and time, a scheduled position, and a scheduled amount for supplying hydrogen to the fuel-cell vessel 7.

The management-side data transmitting unit 13 transmits the supply schedule data to the reception-side terminal apparatus 5 of the certain fuel-cell vessel 7 and the supply-side terminal apparatus 6 of the certain hydrogen supplier vessel 9. According to the supply schedule data, the supply of hydrogen is performed from the certain hydrogen supplier vessel 9 to the certain fuel-cell vessel 7.

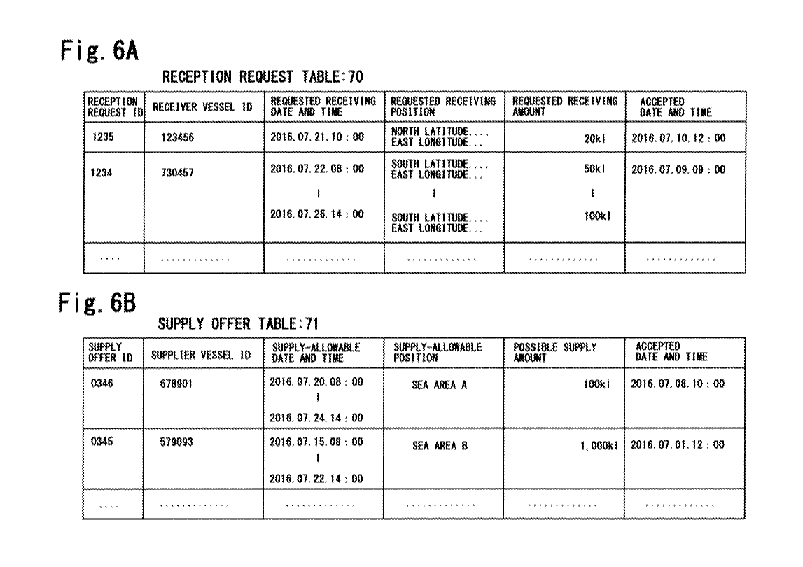

The database 15 includes two tables. FIG. 6A and FIG. 6B are diagrams illustrating an example of a data configuration of the tables constituting the database 15. FIG. 6A is a diagram illustrating an example of the data configuration of a reception request table 70. FIG. 6B is a diagram illustrating an example of the data configuration of a supply offer table 71.

The reception request table 70 is a table in which, whenever the management server apparatus 4 accepts reception request data from the reception-side terminal apparatus 5, a reception request ID related to the reception request data is issued, an accepted date and time is written down, and a vessel ID to identify the fuel-cell vessel 7, a date and time, a position, and an amount requested for the reception of hydrogen, which are contained in the reception request data, are recorded as a receiver vessel ID, a requested receiving date and time, a requested receiving position, and a requested receiving amount.

The supply offer table 71 is a table in which, whenever the management server apparatus 4 accepts supply offer data from the supply-side terminal apparatus 6, a supply offer ID related to the supply offer data is issued, an accepted date and time is written down, and a vessel ID to identify the hydrogen supplier vessel 9, and a date and time, a position, and an amount allowing the supply of hydrogen which are contained in the supply offer data, are recorded as a supplier vessel ID, a supply-allowable date and time, a supply-allowable position, and a possible supply amount.

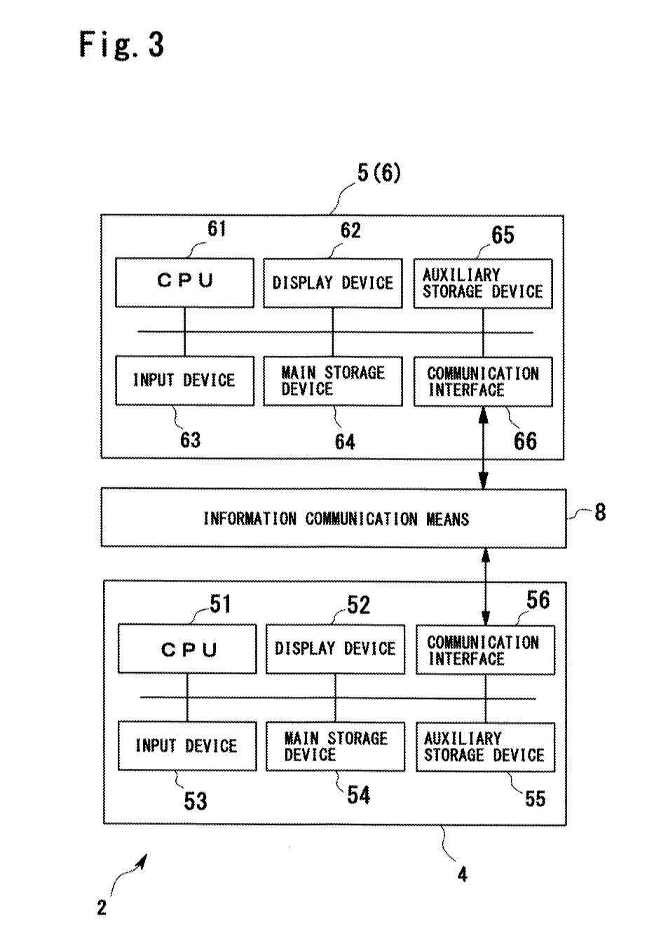

FIG. 3 is a block diagram illustrating an example of a hardware configuration of the management server apparatus 4 and the reception-side terminal apparatus 5 illustrated in FIG. 2, illustrating a case where one computer is used for each of the management server apparatus 4 and the reception-side terminal apparatus 5.

The management server apparatus 4 is not limited in particular and has, in this example, the same configuration as that of a typical server computer.

The management server apparatus 4 includes an auxiliary storage device 55 such as a hard disk drive (HDD) including a hard disk that serves as a recording medium for storing a program used by the management server apparatus 4 of the hydrogen supply supporting system 2 and also serves as a storage medium of the database 15, a main storage device 54 into which the program stored in the auxiliary storage device 55 is loaded, a CPU 51 that is equivalent to the management-side controller 10 and executes the program loaded into the main storage device 54, a display device 52 such as a liquid crystal display (LCD), an input device 53 such as a keyboard, a mouse, and a trackpad, and a communication interface 56 that communicates with the reception-side terminal apparatus 5 and the supply-side terminal apparatus 6 via the information communication means 8.

The reception-side terminal apparatus 5 is not limited in particular and has, in this example, the same configuration as that of a typical personal computer.

The reception-side terminal apparatus 5 includes an auxiliary storage device 65 such as a solid state drive (SSD) including a flash memory that serves as a recording medium for storing a program for the reception-side terminal apparatus 5 of the hydrogen supply supporting system 2, a main storage device 64 into which the program stored in the auxiliary storage device 65 is loaded, a CPU 61 that executes the program loaded into the main storage device 64, a display device 62 such as a liquid crystal display (LCD), an input device 63 such as an input key and a touch panel, and a communication interface 66 that communicates with the management server apparatus 4 via the information communication means 8.

The supply-side terminal apparatus 6 has the same basic hardware configuration as that of the reception-side terminal apparatus 5.

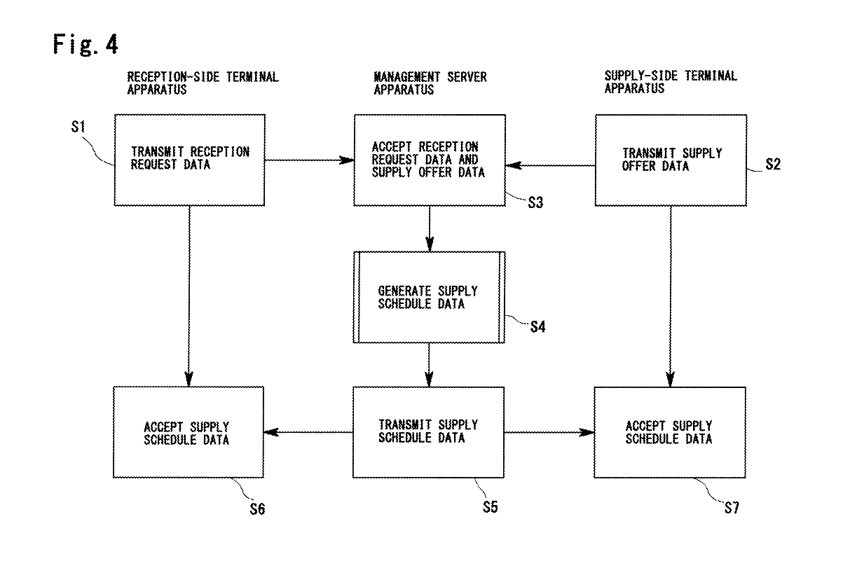

FIG. 4 is a flowchart illustrating an example of a process flow in the hydrogen supply supporting system 2. Referring to this drawing, a procedure performed in the hydrogen supply supporting system 2 is explained.

The reception-side terminal apparatus 5 transmits reception request data to the management server apparatus 4, the reception request data containing a vessel ID to identify the relevant vessel, and a date and time, a position, and an amount requested for the reception of hydrogen (step S1).

The date and time, the position, and the amount requested for the reception of hydrogen contained in the reception request data may be contained explicitly or substantially.

Description will be made here by way of example about a case where the date and time, the position, and the amount requested for the reception of hydrogen contained in the reception request data are contained explicitly. A case where they are contained substantially will be described later.

The reception request data in which the date and time, the position, and the amount requested for the reception of hydrogen are contained explicitly refers to data that explicitly specifies a date and time, a position, and an amount requested for the reception of hydrogen. The data on a date and time, a position, and an amount requested for the reception of hydrogen may have what is called pinpoint values or may have values with flexibility (see FIG. 6A).

The reception request data, for example, may be planned before departure, stored in a storage device of the reception-side terminal apparatus 5 (e.g., the auxiliary storage device 65), and transmitted to the management server apparatus 4 as appropriate.

Alternatively, based on the current status of the fuel-cell vessel 7 in question, for example, reception request data can be calculated using the reception-side controller 20 of the reception-side terminal apparatus 5.

The method for the calculation is not limited in particular and can be calculated based on, for example, data on a scheduled course of the fuel-cell vessel 7 in question (information indicating where and when the fuel-cell vessel 7 is planned to pass, and being updated in accordance with the current status of the fuel-cell vessel 7 in question), data on a maximum loading capacity of hydrogen (may be an upper limit amount obtained by subtracting a preset amount from an actual maximum loading capacity), data on a remaining amount of hydrogen (may be an amount obtained by subtracting a preset lower limit amount from an actual remaining amount), and data on a fuel efficiency (specific fuel consumption).

For example, remaining navigation distance is calculated based on data on a scheduled course, a necessary amount of hydrogen to reach a destination (an amount obtained by multiplying an actually required amount by a predetermined safety factor) is calculated based on the remaining navigation distance and data on a fuel efficiency, and when the remaining amount of hydrogen is smaller than the necessary amount of hydrogen, it is determined that there is a necessity to receive the supply of hydrogen on the scheduled course to go.

In this case, data on a date and time and data on a position requested for reception are calculated based on the data on the remaining amount of hydrogen, the data on the fuel efficiency, and the data on the scheduled course. The data on the date and time and the data on the position requested for reception may be data containing the entire range on a scheduled course to pass along from a current time point up to a time point at which the remaining amount of hydrogen is predicted to become zero, or may be data determined within the range in a pinpoint manner.

Then, the data on the amount of hydrogen requested for reception is calculated based on the data on the maximum loading capacity of hydrogen, the data on the remaining amount of hydrogen, and the data on the necessary amount of hydrogen to reach a destination. For example, the amount obtained by subtracting the remaining amount of hydrogen from the maximum loading capacity of hydrogen (a margin amount to receive hydrogen) is compared with the necessity amount of hydrogen, and when the former is larger, an amount between the latter and the former can be determined to be data on the amount of hydrogen requested for reception, and when the latter is larger, the former can be determined to be data on the amount of hydrogen requested for reception.

In such a manner, it is possible to calculate the reception request data using the reception-side controller 20 of the reception-side terminal apparatus 5.

Meanwhile, the supply-side terminal apparatus 6 transmits supply offer data to the management server apparatus 4, the supply offer data containing a vessel ID to identify the relevant vessel, and a date and time, a position, and an amount allowing the supply of hydrogen (step S2).

The date and time, the position, and the amount allowing the supply of hydrogen contained in the supply offer data may be contained explicitly or substantially.

Description will be made here by way of example about a case where the date and time, the position, and the amount allowing the supply of hydrogen contained in the supply offer data are contained explicitly. A case where they are contained substantially will be described later.

The supply offer data in which the date and time, the position, and the amount allowing the supply of hydrogen are contained explicitly refers to data that explicitly specifies a date and time, a position, and an amount allowing the supply of hydrogen. The data on the date and time, the position, and the amount allowing the supply of hydrogen may have what is called pinpoint values or may have values with flexibility (see FIG. 6B).

The supply offer data, for example, may be planned in advance before departure, stored in a storage device of the supply-side terminal apparatus 6 (e.g., the auxiliary storage device 65), and transmitted to the management server apparatus 4 as appropriate.

Alternatively, based on the current status of the hydrogen supplier vessel 9 in question, for example, supply offer data can be calculated using the supply-side controller 30 of the supply-side terminal apparatus 6.

The method for the calculation is not limited in particular and can be calculated based on, for example, data on a scheduled course of the hydrogen supplier vessel 9 in question (information indicating where and when the hydrogen supplier vessel 9 is planned to pass or indicating what sea area and how long hydrogen supplier vessel 9 is planned to stay in, and being updated in accordance with the current status of the hydrogen supplier vessel 9 in question), data on a current remaining amount of hydrogen to be supplied in the hydrogen supplier vessel 9 in question, and data on a settled amount of hydrogen scheduled to supply (hereinafter, may be referred to as settled scheduled supply amount data).

For example, when an amount obtained by subtracting the settled scheduled supply amount from the current remaining amount of hydrogen to be supplied is equal to or larger than a predetermined amount, it is determined that hydrogen can be supplied to another fuel-cell vessel 7 on the scheduled course to go.

In this case, the data on the date and time and the data on the position allowing the supply of hydrogen based on the data on the scheduled course is calculated. The data on the date and time and the data on the position allowing the supply of hydrogen may be data containing the entire range on a scheduled course, or may be data determined within the range in a pinpoint manner.

Then, based on the data on the current remaining amount of hydrogen to be supplied and the settled scheduled supply amount data, data on a suppliable amount of hydrogen is calculated. For example, an amount obtained by subtracting the settled scheduled supply amount from the current remaining amount of hydrogen to be supplied can be determined to be data on the suppliable amount of hydrogen.

In such a manner, it is possible to calculate the supply offer data using the supply-side controller 30 of the supply-side terminal apparatus 6.

Next, the management server apparatus 4 accepts the reception request data from the reception-side terminal apparatus 5, accepts the supply offer data from the supply-side terminal apparatus 6, and write these accepted data into the database 15 (step S3).

Specifically, when accepting the reception request data, the management server apparatus 4 adds this data to the reception request table 70 as a new record, or updates a record existing in the table having the same receiver vessel ID as that of the data. In addition, when accepting the supply offer data, the management server apparatus 4 adds this data to the supply offer table 71 as a new record, or updates a record existing in the table having the same supplier vessel ID as that of the data.

A record in the reception request table 70 can be invalidated or deleted when supply schedule data corresponding to the record is generated. A record in the supply offer table 71 can be updated when new supply schedule data is accepted from the same hydrogen supplier vessel 9.

Afterward, the management server apparatus 4 generates supply schedule data based on the accepted reception request data and supply offer data (step S4). The supply schedule data is data containing a vessel ID of a certain fuel-cell vessel 7 to receive the supply of hydrogen, a vessel ID of a certain hydrogen supplier vessel 9 to supply hydrogen to the fuel-cell vessel 7, a scheduled date and time, a scheduled position, and a scheduled amount for supplying hydrogen to the fuel-cell vessel 7.

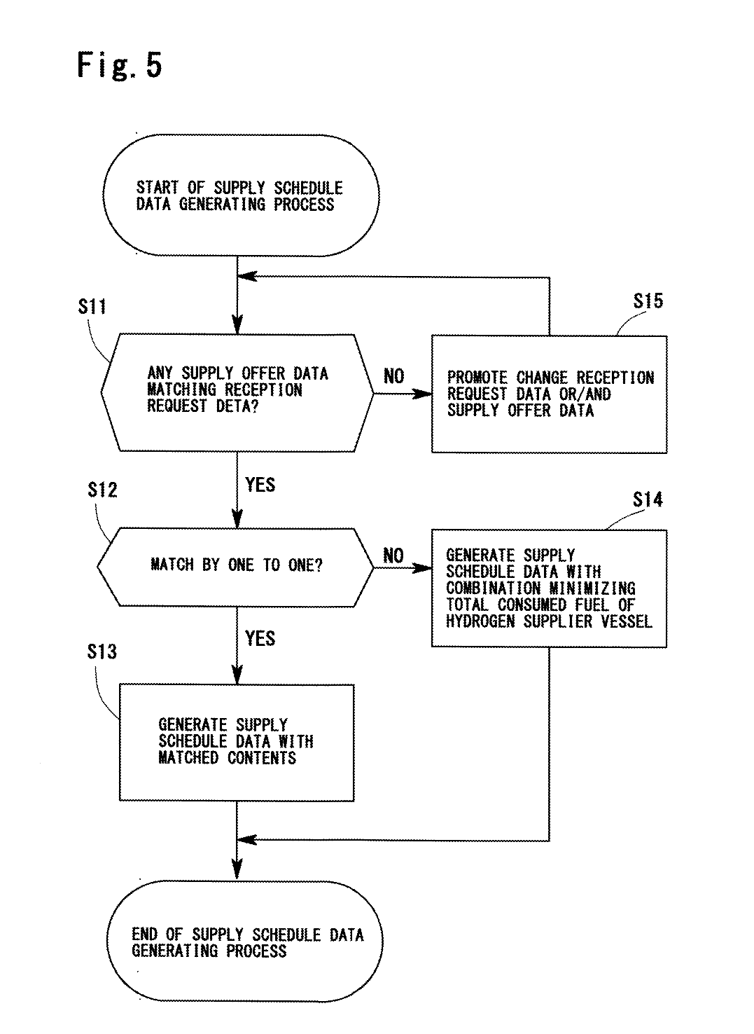

The process of in step S4 in FIG. 4 is illustrated in detail in FIG. 5.

In FIG. 5, the management server apparatus 4 compares each item of reception request data in the reception request table 70 with each item of supply offer data in the supply offer table 71 to determine whether or not there is any item of supply offer data matching any item of reception request data (step S11).

When a requested receiving date and time, a requested receiving position, and a requested receiving amount in a certain item of reception request data match, respectively, a supply-allowable date and time, a supply-allowable position, and a possible supply amount in a certain supply offer data, it is determined that the certain item of reception request data matches the certain item of supply offer data. In the case of data with flexibility (e.g., data on a date and time has flexibility), these items of data are determined to match each other when part of compared data falls within the data with flexibility.

Next, the management server apparatus 4 determines whether or not any item of reception request data matches any item of supply offer data by one to one (step S12).

When they match each other by one to one, supply schedule data is generated with the matched contents (step S13).

In step S12, when they do not match each other one on one, in other words, when reception request data and supply offer data match each other by one to many, many to one, or many to many, the management server apparatus 4 determines a combination of an items of such reception request data and supply offer data that minimizes the total sum of consumed fuel (or consumed fuel cost) of a hydrogen supplier vessel 9 required for the supply of hydrogen, and supply schedule data is generated in accordance with the combination (step S14).

For example, when reception request data and supply offer data match each other by one to many, a hydrogen supplier vessel 9 that minimizes fuel (or fuel cost) required for the supply of hydrogen to an applicable fuel-cell vessel 7 is determined from among all applicable hydrogen supplier vessels 9, and supply schedule data is generated in accordance with the combination of the applicable fuel-cell vessel 7 and the determined hydrogen supplier vessel 9.

When reception request data and supply offer data match each other by many to one, assuming that an applicable hydrogen supplier vessel 9 is to supply hydrogen to all applicable fuel-cell vessels 7 in turn, an order (route) is determined that minimizes the total amount of fuel (or fuel cost) to be consumed by the hydrogen supplier vessel 9 in the supply, and supply schedule data is generated in accordance with a combination of the hydrogen supplier vessel 9 and the fuel-cell vessels 7 in the order.

When reception request data and supply offer data match each other by many to many, assuming that hydrogen is supplied to all applicable fuel-cell vessels 7, a combination of fuel-cell vessels 7 and one or more hydrogen supplier vessels 9 to take charge of the supply is determined that minimizes the total amount of fuel (or fuel cost) consumed by the hydrogen supplier vessels 9, and supply schedule data is generated in accordance with the combination.

At this point, for example, a conceivable method is to conduct an exhaustive simulation of which hydrogen supplier vessel 9 supplies hydrogen to which fuel-cell vessel 7 in which order (route) for all the applicable fuel-cell vessels 7 and all the hydrogen supplier vessels 9, and compare the total amounts of consumed fuel (or fuel cost) of the hydrogen supplier vessels 9 in all the cases.

When it is determined in step S11 that there is no supply offer data matching reception request data, the management server apparatus 4 promotes a fuel-cell vessel 7 corresponding to the reception request data to change the reception request data, or promotes a hydrogen supplier vessel 9 to change supply offer data (step S15). When these data are changed, corresponding records in the database 15 are updated with the change data, and the processes of step S11 and subsequent steps is performed based on the updated data.

In such a manner, items of supply schedule data are generated on all items of reception request data. In generating the items of supply schedule data, of course, weather conditions, military situations, and circumstances due to inevitabilities are taken into consideration.

Returning to FIG. 4, the management server apparatus 4 transmits the generated supply schedule data to the reception-side terminal apparatus 5 of a fuel-cell vessel 7 corresponding to the supply schedule data and the supply-side terminal apparatus 6 of a hydrogen supplier vessel 9 corresponding to the supply schedule data (step S5).

The reception-side terminal apparatus 5 accepts the supply schedule data (step S6), and the fuel-cell vessel 7 is to receive the supply of hydrogen in accordance with the supply schedule data.

The supply-side terminal apparatus 6 accepts the supply schedule data (step S7), and the hydrogen supplier vessel 9 is to supply hydrogen in accordance with the supply schedule data.

The aforementioned embodiment has been described by way of example about the case where a date and time, a position, and an amount requested for the reception of hydrogen are contained explicitly in reception request data transmitted to management server apparatus 4 (hereinafter, reception request data in such a case may be referred to as explicit reception request data), and as mentioned previously, the present invention also includes a case where they are contained substantially (hereinafter, reception request data in such a case may be referred to as substantial reception request data).

Here, substantial reception request data refers to data that allows explicit reception request data to be obtained based on the substantial reception request data, or the substantial reception request data and known data (data on the fuel-cell vessel 7 in question that is known and stored in the management server apparatus 4). Substantial reception request data includes, for example, data containing data on a scheduled course of the fuel-cell vessel 7, data on a maximum loading capacity of hydrogen, data on a remaining amount of hydrogen, and data on a fuel efficiency.

In this case, the management server apparatus 4 can be configured to generate, in step S3 for example, explicit reception request data based on the accepted substantial reception request data on the fuel-cell vessel 7 in question, and write the generated data into the reception request table 70.

As a method for generating the explicit reception request data, use can be made of a calculation method of the case of, in step S1 described above for example, calculating explicit reception request data using the reception-side controller 20 of the reception-side terminal apparatus 5.

In the above calculation method, for example, when data on a maximum loading capacity of hydrogen of the fuel-cell vessel 7 in question and data on a fuel efficiency are known data, the substantial reception request data on the fuel-cell vessel 7 in question can be regarded as data containing data on a scheduled course and data on a remaining amount of hydrogen. Furthermore, of the data on a scheduled course, when data on a navigation route (a series of items of position data) and a scheduled navigation speed of the fuel-cell vessel 7 in question on the route are also known data, the substantial reception request data on the fuel-cell vessel 7 in question can be regarded as data containing data on a current position and data on a remaining amount of hydrogen.

In this case, for example, substantial reception request data containing the data on the remaining amount of hydrogen at that point and data on a current position can be configured to be automatically generated and transmitted to the management server apparatus 4 when data on the remaining amount of hydrogen becomes less than a predetermined amount. With such a configuration, it is possible to automatically accept supply schedule data from the management server apparatus 4 as appropriate while crews of a fuel-cell vessel 7 do not have to perform a special operation.

In addition, the aforementioned embodiment has been described by way of example about the case where a date and time, a position, and an amount allowing the supply of hydrogen are contained explicitly in supply offer data transmitted to the management server apparatus 4 (hereinafter, supply offer data in such a case may be referred to as explicit supply offer data), and as mentioned previously, the present invention also include a case where they are contained substantially (hereinafter, supply offer data in such a case may be referred to as substantial supply offer data).

Here, substantial supply offer data refers to data that allows explicit supply offer data to be obtained based on the substantial supply offer data, or the substantial supply offer data and known data (data on the hydrogen supplier vessel 9 in question that is known and stored in the management server apparatus 4). Substantial supply offer data includes, for example, data containing data on a scheduled course of the hydrogen supplier vessel 9, data on a current remaining amount of hydrogen to be supplied, and settled scheduled supply amount data.

In this case, the management server apparatus 4 can be configured to generate, in step S3 for example, explicit supply offer data based on the accepted substantial supply offer data on the hydrogen supplier vessel 9 in question, and write the generated data into the supply offer table 71.

As a method for generating the explicit supply offer data, use can be made of a calculation method of the case of, in step S2 for example, calculating explicit supply offer data using the supply-side controller 30 of the supply-side terminal apparatus 6.

In the above calculation method, for example, when settled scheduled supply amount data on the hydrogen supplier vessel 9 in question is known data, the substantial supply offer data on the hydrogen supplier vessel 9 in question can be regarded as data containing data on a scheduled course and data on a current remaining amount of hydrogen to be supplied. Furthermore, of the data on a scheduled course, when data on a navigation route (a series of items of position data) and a scheduled navigation speed of the hydrogen supplier vessel 9 in question on the route are also known data, the substantial supply offer data on the hydrogen supplier vessel 9 in question can be regarded as data containing data on a current position and data on a current remaining amount of hydrogen to be supplied.

In this case, for example, substantial supply offer data containing data on a current position and data on a remaining amount of hydrogen to be supplied can be configured to be periodically generated and transmitted to the management server apparatus 4. With such a configuration, it is possible to automatically transmit supply offer data to the management server apparatus 4 and update the contents of supply offer data while crews of a hydrogen supplier vessel 9 do not have to perform a special operation.

In addition, the aforementioned embodiment has been described by way of example about a fuel-cell vessel as a hydrogen receiver vessel, but this does not limit the hydrogen receiver vessel. The hydrogen receiver vessel includes vessels in general that obtain energy in some form such as motive power and electric power using hydrogen as fuel for either a main engine or an auxiliary engine, as well as vessels that need the reception of hydrogen in their navigations for some reason. Therefore, the hydrogen receiver vessel may also include hydrogen supplier vessels that need the reception of hydrogen to supply hydrogen to other vessels.

The aforementioned embodiment has been described by way of example about the case where the management server apparatus, the reception-side terminal apparatus, and the supply-side terminal apparatus each use a computer, but this does not limit the present invention. The management server apparatus, the reception-side terminal apparatus and/or the supply-side terminal apparatus can be each constituted by a set of two or more computers. In this case, two or more computers constituting a set can be connected to each other via the information communication means 8.

Step S1 illustrated in FIG. 4 corresponds to the reception-side data transmitting unit 21 of the reception-side terminal apparatus 5 in FIG. 2. Step S2 corresponds to the supply-side data transmitting unit 31 of the supply-side terminal apparatus 6. Step S3 corresponds to the management-side data accepting unit 11 of the management server apparatus 4. Step S4 corresponds to the supply schedule data generating unit 12 of the management server apparatus 4. Step S5 corresponds to the management-side data transmitting unit 13 of the management server apparatus 4. Step S6 corresponds to the reception-side data accepting unit 22 of the reception-side terminal apparatus 5. Step S7 corresponds to the supply-side data accepting unit 32 of the supply-side terminal apparatus 6.

In this embodiment, as a recording medium which stores programs used by the management server apparatus 4 of the hydrogen supply supporting system 2, there is illustrated a hard disk attached to a HDD. As a recording medium which stores programs used by the reception-side terminal apparatus 5 or the supply-side terminal apparatus 6, there is illustrated a flash memory attached to a SSD. However, a recording medium which stores programs shall not be limited thereto. A recording medium which stores programs includes, for example, an external memory card, a CD-ROM, a DVD-ROM, a flexible disk and an electromagnetic tape. A main storage device can also be used as a recording medium which stores programs.

There are no particular restrictions on a distributing mode of a program. The program may be distributed in a state that the program is stored in a recording medium or the program may be distributed via wire or wireless information communication means.

There are no particular restrictions on a recording mode of a program. The program may be stored in a recording medium or distributed so as to be directly executed. Alternatively, for example, the program may be stored in a recording medium or distributed in a state of compression so as to be used after decompression.

In each of the above described embodiments, a description has been given of a case where a computer is used to realize each of the functions shown in FIG. 2. However, it is also acceptable that a part or a whole of the functions may be configured by using hardware logic.

Further, the above described block diagrams, arrangements of hardware, flow charts, arrangements of database etc., are only examples. The present application shall not be, however, limited thereto.

A hydrogen supply supporting system according to the first invention of the present application is a hydrogen supply supporting system including reception-side terminal apparatuses that are provided, respectively, in a plurality of hydrogen receiver vessels to receive supply of hydrogen, supply-side terminal apparatuses that are provided, respectively, in a plurality of hydrogen supplier vessels to supply hydrogen, and a management server apparatus that can communicate information with the reception-side terminal apparatuses and the supply-side terminal apparatuses via information communication means, the hydrogen supply supporting system supporting supply of hydrogen from the hydrogen supplier vessel to the hydrogen receiver vessel on a course of the hydrogen receiver vessel, wherein the reception-side terminal apparatuses each include a reception-side controller including: a reception-side data transmitting unit that transmits reception request data to the management server apparatus, the reception request data containing a vessel ID to identify the vessel, and a date and time, a position, and an amount requested for reception of hydrogen; and a reception-side data accepting unit that accepts supply schedule data corresponding to reception request data from the management server apparatus, and the supply-side terminal apparatuses each include a supply-side controller including: a supply-side data transmitting unit that transmits supply offer data to the management server apparatus, the supply offer data containing a vessel ID to identify the vessel, and a date and time, a position, and an amount allowing supply of hydrogen; and a supply-side data accepting unit that accepts supply schedule data corresponding to supply offer data from the management server apparatus, and the management server apparatus includes a management-side controller including: a management-side data accepting unit that accepts reception request data from the reception-side terminal apparatus and accepts supply offer data from the supply-side terminal apparatus; a supply schedule data generating unit that generates, based on the accepted reception request data and supply offer data, supply schedule data containing a vessel ID of a certain hydrogen receiver vessel to receive supply of hydrogen, a vessel ID of a certain hydrogen supplier vessel to supply hydrogen to the certain hydrogen receiver vessel, and a scheduled date and time, a scheduled position, and a scheduled amount for supplying hydrogen to the certain hydrogen receiver vessel; and a management-side data transmitting unit that transmits the supply schedule data to the reception-side terminal apparatus and the supply-side terminal apparatus.

In such a manner, the hydrogen receiver vessel transmits reception request data to the management server apparatus, so as to be able to receive the supply of hydrogen from the hydrogen supplier vessel on its course.

Therefore, in the hydrogen receiver vessel, it is not necessary to provide facilities necessary to produce hydrogen or increase the volume of a fuel tank for storing hydrogen, and thus space for persons or cargoes will not be reduced. In addition, it is not necessary to make a port call for refueling, and thus a navigation distance and a required time to a destination will not be prolonged.

In other words, for a hydrogen receiver vessel such as a fuel-cell vessel, it is possible to implement a system that enables long-distance navigations without resulting in decreasing transport efficiency.

A management server apparatus according to the second invention of the present application is a management server apparatus used in the hydrogen supply supporting system according to the first invention of the present application.

Therefore, using this management server apparatus in a hydrogen supply supporting system exerts the same effect as that of the first invention described above.

A reception-side terminal apparatus according to the third invention of the present application is a reception-side terminal apparatus used in the hydrogen supply supporting system according to the first invention of the present application.

Therefore, using this reception-side terminal apparatus in a hydrogen supply supporting system exerts the same effect as that of the first invention described above.

A supply-side terminal apparatus according to the fourth invention of the present application is a supply-side terminal apparatus used in the hydrogen supply supporting system according to the first invention of the present application.

Therefore, using this supply-side terminal apparatus in a hydrogen supply supporting system exerts the same effect as that of the first invention described above.

A program according to the fifth invention of the present application is a program for causing a computer to function as the management-side controller of the management server apparatus according to the second invention of the present application, the reception-side controller of the reception-side terminal apparatus according to the third invention, or the supply-side controller of the supply-side terminal apparatus according to the fourth invention.

Therefore, causing a computer to execution the program exerts the same effect as that of the second invention, the third invention, or the fourth invention described above.

A recording medium according to the sixth invention of the present application is a recording medium in which the program according to the fifth invention of the present application is stored.

Therefore, causing a computer to execute the program stored in the recording medium exerts the same effect as that of the above fifth invention.

A hydrogen supply supporting method according to the seventh invention of the present application is a hydrogen supply supporting method using reception-side terminal apparatuses that are provided, respectively, in a plurality of hydrogen receiver vessels to receive supply of hydrogen, supply-side terminal apparatuses that are provided, respectively, in a plurality of hydrogen supplier vessels to supply hydrogen, and a management server apparatus that can communicate information with the reception-side terminal apparatuses and the supply-side terminal apparatuses via information communication means, so as to support supply of hydrogen from the hydrogen supplier vessel to the hydrogen receiver vessel on a course of the hydrogen receiver vessel, the hydrogen supply supporting method comprising: a reception-side data transmitting step, by the reception-side terminal apparatus, of transmitting reception request data to the management server apparatus, the reception request data containing a vessel ID to identify the vessel, and a date and time, a position, and an amount requested for reception of hydrogen; a supply-side data transmitting step, by the supply-side terminal apparatus, of transmitting supply offer data to the management server apparatus, the supply offer data containing a vessel ID to identify the vessel, and a date and time, a position, and an amount allowing supply of hydrogen; a management-side data accepting step, by the management server apparatus, of accepting reception request data from the reception-side terminal apparatus and accepting supply offer data from the supply-side terminal apparatus; a supply schedule data generating step, by the management server apparatus, of generating, based on the accepted reception request data and supply offer data, supply schedule data that contains a vessel ID of a certain hydrogen receiver vessel to receive supply of hydrogen, a vessel ID of a certain hydrogen supplier vessel to supply hydrogen to the certain hydrogen receiver vessel, a scheduled date and time, a scheduled position, and a scheduled amount for supplying hydrogen to the certain hydrogen receiver vessel; a management-side data transmitting step, by the management server apparatus, of transmitting supply schedule data to the reception-side terminal apparatus and the supply-side terminal apparatus; a reception-side data accepting step, by the reception-side terminal apparatus, of accepting supply schedule data corresponding to reception request data from the management server apparatus; and a supply-side data accepting step, by the supply-side terminal apparatus, of accepting supply schedule data corresponding to supply offer data from the management server apparatus.

Therefore, using the method with the hydrogen supply supporting system exerts the same effect as that of the above first invention, the hydrogen supply supporting system including the reception-side terminal apparatuses that are provided, respectively, in the plurality of hydrogen receiver vessels to receive the supply of hydrogen, the supply-side terminal apparatuses that are provided, respectively, in the plurality of hydrogen supplier vessels to supply hydrogen, and the management server apparatus that can communicate information with the reception-side terminal apparatuses and the supply-side terminal apparatuses via the information communication means, and supporting the supply of hydrogen from a hydrogen supplier vessel to a hydrogen receiver vessel on a course of the hydrogen receiver vessel.

What is claimed is:

1. A hydrogen supply supporting system comprising:
reception-side terminal apparatuses that are provided, respectively, in a plurality of hydrogen receiver vessels to receive supply of hydrogen;
supply-side terminal apparatuses that are provided, respectively, in a plurality of hydrogen supplier vessels to supply hydrogen; and
a management server apparatus that can communicate information with the reception-side terminal apparatuses and the supply-side terminal apparatuses via information communication means,
the hydrogen supply supporting system supporting supply of hydrogen from the hydrogen supplier vessel to the hydrogen receiver vessel on a course of the hydrogen receiver vessel, wherein
the reception-side terminal apparatuses each include a reception-side controller including:
a reception-side data transmitting unit that transmits reception request data to the management server apparatus, the reception request data containing a vessel ID to identify the vessel, and a date and time, a position, and an amount requested for reception of hydrogen; and
a reception-side data accepting unit that accepts supply schedule data corresponding to reception request data from the management server apparatus, and
the supply-side terminal apparatuses each include a supply-side controller including:
a supply-side data transmitting unit that transmits supply offer data to the management server apparatus, the supply offer data containing a vessel ID to identify the vessel, and a date and time, a position, and an amount allowing supply of hydrogen; and
a supply-side data accepting unit that accepts supply schedule data corresponding to supply offer data from the management server apparatus, and
the management server apparatus includes a management-side controller including:
a management-side data accepting unit that accepts reception request data from the reception-side terminal apparatus and accepts supply offer data from the supply-side terminal apparatus;
a supply schedule data generating unit that generates, based on the accepted reception request data and supply offer data, supply schedule data containing a vessel ID of a certain hydrogen receiver vessel to receive supply of hydrogen, a vessel ID of a certain hydrogen supplier vessel to supply hydrogen to the certain hydrogen receiver vessel, and a scheduled date and time, a scheduled position, and a scheduled amount for supplying hydrogen to the certain hydrogen receiver vessel; and
a management-side data transmitting unit that transmits the supply schedule data to the reception-side terminal apparatus and the supply-side terminal apparatus.

2. A management server apparatus used in the hydrogen supply supporting system according to claim 1.

3. A reception-side terminal apparatus used in the hydrogen supply supporting system according to claim 1.

4. A supply-side terminal apparatus used in the hydrogen supply supporting system according to claim 1.

5. A program for causing a computer to function as the management-side controller of the management server apparatus according to claim 2.

6. A recording medium in which the program according to claim 5 is stored.

7. A hydrogen supply supporting method using reception-side terminal apparatuses that are provided, respectively, in a plurality of hydrogen receiver vessels to receive supply of hydrogen, supply-side terminal apparatuses that are provided, respectively, in a plurality of hydrogen supplier vessels to supply hydrogen, and a management server apparatus that can communicate information with the reception-side terminal apparatuses and the supply-side terminal apparatuses via information communication means, so as to support supply of hydrogen from the hydrogen supplier vessel to the hydrogen receiver vessel on a course of the hydrogen receiver vessel, the hydrogen supply supporting method comprising:
a reception-side data transmitting step, by the reception-side terminal apparatus, of transmitting reception request data to the management server apparatus, the reception request data containing a vessel ID to identify the vessel, and a date and time, a position, and an amount requested for reception of hydrogen;
a supply-side data transmitting step, by the supply-side terminal apparatus, of transmitting supply offer data to the management server apparatus, the supply offer data containing a vessel ID to identify the vessel, and a date and time, a position, and an amount allowing supply of hydrogen;
a management-side data accepting step, by the management server apparatus, of accepting reception request data from the reception-side terminal apparatus and accepting supply offer data from the supply-side terminal apparatus;
a supply schedule data generating step, by the management server apparatus, of generating, based on the accepted reception request data and supply offer data, supply schedule data that contains a vessel ID of a certain hydrogen receiver vessel to receive supply of hydrogen, a vessel ID of a certain hydrogen supplier vessel to supply hydrogen to the certain hydrogen receiver vessel, a scheduled date and time, a scheduled position, and a scheduled amount for supplying hydrogen to the certain hydrogen receiver vessel;
a management-side data transmitting step, by the management server apparatus, of transmitting supply schedule data to the reception-side terminal apparatus and the supply-side terminal apparatus;
a reception-side data accepting step, by the reception-side terminal apparatus, of accepting supply schedule data corresponding to reception request data from the management server apparatus; and
a supply-side data accepting step, by the supply-side terminal apparatus, of accepting supply schedule data corresponding to supply offer data from the management server apparatus.

8. The hydrogen supply supporting system according to claim 1, wherein the reception-side terminal apparatus is configured to transmit reception request data to the management server apparatus as appropriate, the reception request data being planned in advance before departure of the hydrogen receiver vessel and stored in a storage device of the reception-side terminal apparatus.

9. The hydrogen supply supporting system according to claim 1, wherein
the hydrogen receiver vessel is a fuel-cell vessel, and
the reception-side terminal apparatus is configured to calculate reception request data based on data on a scheduled course, data on a maximum loading capacity of hydrogen, data on a remaining amount of hydrogen, and data on a fuel efficiency, of the fuel-cell vessel.

10. The hydrogen supply supporting system according to claim 9, wherein
the reception-side terminal apparatus is configured to
calculate a remaining navigation distance based on the data on the scheduled course,
calculate a necessary amount of hydrogen to reach a destination based on the remaining navigation distance and the data on the fuel efficiency,
determine that there is a necessity to receive supply of hydrogen on the scheduled course to go when the remaining amount of hydrogen is less than the necessary amount of hydrogen,
calculate data on a date and time and data on a position requested for reception based on the data on the remaining amount of hydrogen, the data on the fuel efficiency, and the data on the scheduled course, and
calculate data on an amount of hydrogen requested for reception based on the data on the maximum loading capacity of hydrogen, the data on the remaining amount of hydrogen, and the data on the necessary amount of hydrogen to reach the destination.

11. The hydrogen supply supporting system according to claim 10, wherein
the reception-side terminal apparatus is configured to
compare an amount obtained by subtracting the remaining amount of hydrogen from the maximum loading capacity of hydrogen with the necessary amount of hydrogen, determine an amount between the latter and the former to be data on an amount of hydrogen requested for reception when the former is larger, and determine the former to be data on an amount of hydrogen requested for reception when the latter is larger.

12. The hydrogen supply supporting system according to claim 1, wherein the supply-side terminal apparatus is configured to calculate supply offer data based on data on a scheduled course of a hydrogen supplier vessel, data on a current remaining amount of hydrogen to be supplied of the hydrogen supplier vessel, and settled scheduled supply amount data, which is data on a settled amount of hydrogen scheduled to supply.

13. The hydrogen supply supporting system according to claim 12, wherein
the supply-side terminal apparatus is configured to
determine that hydrogen can be supplied to another hydrogen receiver vessel on a scheduled course to go when an amount obtained by subtracting the settled scheduled supply amount from the current remaining amount of hydrogen to be supplied is equal to or larger than a predetermined amount,
calculate data on a date and time and data on a position allowing supply of hydrogen based on data on a scheduled course, and
calculate data on a suppliable amount of hydrogen based on the data on a current remaining amount of hydrogen to be supplied and the settled scheduled supply amount data.

14. The hydrogen supply supporting system according to claim 13, wherein the supply-side terminal apparatus is configured to determine the amount obtained by subtracting the settled scheduled supply amount from the current remaining amount of hydrogen to be supplied, to be data on the suppliable amount of hydrogen.

15. The hydrogen supply supporting system according to claim 1, wherein
the management server apparatus is configured to
when a requested receiving date and time, a requested receiving position, and a requested receiving amount in accepted reception request data match, respectively, a supply-allowable date and time, a supply-allowable position, and a possible supply amount in accepted supply offer data, determine that the item of reception request data matches the item of supply offer data, and
in a case where the accepted data has flexibility, when part of compared data falls within part of the data having the flexibility, determine that the compared data matches the data having the flexibility.

16. The hydrogen supply supporting system according to claim 15, wherein
the management server apparatus is configured to
determine whether or not the accepted reception request data and supply offer data match each other by one to one,
when the accepted reception request data and supply offer data match each other by one to one, generates supply schedule data with matched contents, and
when the accepted reception request data and supply offer data do not match each other by one to one, in other words, when the reception request data and the supply offer data match each other by one to many, many to one, or many to many, determine a combination that minimizes a total sum of consumed fuel or consumed fuel cost of hydrogen supplier vessel required for supply of hydrogen, and generate supply schedule data in accordance with the combination.

17. The hydrogen supply supporting system according to claim 16, wherein
the management server apparatus is configured to
when the reception request data and the supply offer data match each other by one to many, determines a hydrogen supplier vessel that minimizes fuel or fuel cost required for supply of hydrogen to the hydrogen receiver vessel, from among all applicable hydrogen supplier vessels, and generate supply schedule data in accordance with a combination of the hydrogen supplier vessel and the hydrogen receiver vessel.

18. The hydrogen supply supporting system according to claim 16, wherein
the management server apparatus is configured to
when the reception request data and the supply offer data match each other by many to one, assuming that the hydrogen supplier vessel is to supply hydrogen to all applicable hydrogen receiver vessels in turn, determine an order that minimizes a total amount of fuel or fuel cost to be consumed by the hydrogen supplier vessel in the supply, and generate supply schedule data in accordance with a combination of the hydrogen supplier vessel and the hydrogen receiver vessels in the order.

19. The hydrogen supply supporting system according to claim 16, wherein
the management server apparatus is configured to
when the reception request data and the supply offer data match each other by many to many, assuming that hydrogen is supplied to all applicable hydrogen receiver vessels, determine a combination of hydrogen receiver vessels and one or more hydrogen supplier vessels to take charge of the supply, the combination minimizing a total amount of fuel or fuel cost consumed by the hydrogen supplier vessels, and generate supply schedule data in accordance with the combination.

20. The hydrogen supply supporting system according to claim 19, wherein
the management server apparatus is configured to
conduct an exhaustive simulation of which hydrogen supplier vessel supplies hydrogen to which hydrogen receiver vessel in which order for all the applicable hydrogen receiver vessels and all the applicable hydrogen supplier vessels and compare a total amount fuel or fuel cost consumed by the hydrogen supplier vessels, and
generate supply schedule data in accordance with a combination of the hydrogen receiver vessels and the hydrogen supplier vessels that minimizes the total amount.
